(19) United States
(12) Patent Application Publication
(10) Pub. No.: US 2014/0289139 A1
(43) Pub. Date: Sep. 25, 2014

(54) VIRAL ENGAGEMENT PATH FOR OCCASION-BASED SOCIAL NETWORK

(71) Applicant: No Plan B Productions, LLC, Woodside, CA (US)

(72) Inventor: Sani El-Fishawy, Woodside, CA (US)

(73) Assignee: No Plan B Productions, LLC, Woodside, CA (US)

(21) Appl. No.: 14/095,880

(22) Filed: Dec. 3, 2013

Related U.S. Application Data
(60) Provisional application No. 61/732,874, filed on Dec. 3, 2012.
(60) Provisional application No. 61/732,887, filed on Dec. 3, 2012.

(51) Int. Cl. G06Q 50/00; G06Q 10/00

(52) U.S. Cl. CPC G06Q 50/01; G06Q 10/00
USPC 705/319

(57) ABSTRACT

An example embodiment includes a viral engagement process for increasing participation in an occasion-based social network. The process includes receiving a first photo generated at an occasion. The first photo is transmitted from a first device of a first attendee. The process also includes engaging the first attendee to obtain information concerning the occasion. The process also includes identifying a second attendee present at the occasion. The process also includes notifying the second attendee to engage the second attendee. The process also includes receiving a second photo generated at the occasion. The second photo is transmitted from a second device of the second attendee.

### CROSS-REFERENCE TO RELATED APPLICATIONS

This patent application claims the benefit of and priority to U.S. Provisional Patent Applications Nos.: 61/732,874 and 61/732,887 filed Dec. 3, 2012, which are incorporated herein by reference in their entireties.

### FIELD

Embodiments described herein relate to engagement paths for occasion-based social networks.

### BACKGROUND

With advancements in mobile devices, social networks, and ubiquitous internet connectivity, the ability to generate photos and/or other media files (generically “media files”) and to communicate the media files has increased significantly in recent years. For example, an individual can easily take a photograph or a video with a smart phone and send the photograph or the video to the individual's friends. These advancements in technology have increased the number of media files generated and the number of individuals using devices to generate media files. With the increases in the number of individuals using devices to generate media files and the number of media files generated, it becomes increasingly difficult to share and access media files in an organized fashion.

Currently, individuals can utilize social networks to share and access photos and other media files. The three main types of social networks established today that enable sharing and accessing of photos and other media files include “friend request/accept” social networks, “follower” social networks, and “group-based, broadcasting” social networks. Each social network corresponds to a social graph, which is a data structure stored or represented in a tangible computer-readable medium. The social graph for each social network defines relationships between individuals and facilitates communication within the relationship model on which the social network is built.

Many photos are taken at occasions that have anywhere from a few to hundreds or more attendees. Such occasions include, for example, weddings, informal parties, barbecues, vacations, sporting events, school events, family outings, or any other events where multiple individuals assemble for a common activity or at a common location. Depending on the nature of the occasions, all or most attendees may know each other, there may be some level of acquaintance between attendees, or most attendees will have not yet met each other. In occasions that include more than one attendee, digital photos are taken and other media files are generated by multiple individuals. There is often a strong desire to share and see photos taken by other individuals at the occasion.

Each of the types of existing social networks enables individuals to share media files. However, each suffers from various drawbacks, particularly in relation to the ability to establish relationships that enable photos or other media files to be shared in a meaningful way in connection with occasions having multiple attendees. Specifically, in “friend request/accept” social networks, such as Facebook, when an individual shares media files from an occasion, the media file typically appears in the individual's friends feeds. These feeds are regulated by the social network's knowledge of the individual's friends and/or are regulated by general knowledge about the nature of the relationship between the individual and the individual's friends. The general knowledge may include a number of times a friend has commented and/or liked the individual's posts, for instance. By presenting the media file in the individual's feed regulated by the general information, the media file is not shared with individuals who were at the occasion, but are not the individual's friends, and who are likely interested in the media file. Additionally, the media file is shared with the friends who did not attend the occasion and who are probably not interested in viewing the media file. Because “friend/accept” social networks like Facebook do a poor job of discriminating which of an individual's friends are interested in seeing media files from a particular occasion, individuals tend to self-censor what they post out of fear of “spamming” friends in their social network who are not interested. Accordingly, individuals on a “friend/accept” social network like Facebook tend to submit only a few select photos from an occasion. Ideally, individuals should be able to submit all of their photos or media files created at an occasion, have the photos preserved along with the photos created by others at the occasion, and have the social network intelligently organize and present them only to interested parties. Additionally, in “friend/accept” social networks, albums created by the individual are restricted to media files generated by the individual rather than compiling all media files generated at an occasion.

In “follower” social networks, such as Twitter and Instagram, the media files generated at an occasion are indiscriminately broadcast to all of an individual's followers. Many of the followers were not present at the occasion and likely not interested in the media files. Additionally, the individual cannot view or otherwise access the media files generated by other individuals who attended the occasion without establishing a follower relationship. Also, those at the occasion who are likely interested in the media files created by the individual may not get to see the photos of other attendees as they may not be followers of the individual on the social network. Additionally, in “follower” social networks, albums created by the individual are restricted to media files generated by the individual rather than compiling all media files generated at an occasion.

Likewise, in “group-based, broadcasting” social networks, such as Google Circles, an individual broadcasts a media file generated at an occasion to all individuals in the group. The group usually has been created prior to the occasion based on some commonality among the members of the group. Thus, the individual broadcasts the media file to potentially disinterested individuals who did not attend the occasion. In addition, the media files are only shared with the group, limiting access to individuals not included in the group who attended the occasion. Additionally, in “group-based, broadcasting” social networks, albums created by the individual are restricted to media files generated by the individual rather than compiling all media files generated at an occasion.

In sum, using the existing types of social networks, media files generated at an occasion are not viewable or accessible to all individual who attended the occasion. Instead, the existing types of social networks restrict access to friends, followers, or members of a predefined group. Additionally, a viewing experience is based on a predefined relationship or irrelevant general information concerning the relationship between an individual who produced the media file and a friend. Finally, albums created by an individual are restricted to media files generated by the individual rather than compiling all media files generated at an occasion.

The subject matter claimed herein is not limited to embodiments that solve any disadvantages or that operate only in environments such as those described above. Additionally, unless otherwise indicated herein, the materials described herein are not prior art to the claims in the present application and are not admitted to be prior art by inclusion in this section. Rather, this background is only provided to illustrate one example technology area where some embodiments described herein may be practiced.

### SUMMARY

An example embodiment includes a viral engagement process for increasing participation in an occasion-based social network. The process includes receiving a first photo generated at an occasion. The first photo is transmitted from a first device of a first attendee. The process also includes engaging the first attendee to obtain information concerning the occasion. The process also includes identifying a second attendee present at the occasion. The process also includes notifying the second attendee to engage the second attendee. The process also includes receiving a second photo generated at the occasion. The second photo is transmitted from a second device of the second attendee.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of some embodiments, a more particular description will be rendered by reference to specific embodiments thereof which are illustrated in the appended drawings. It is appreciated that these drawings depict only typical embodiments and are therefore not to be considered limiting of its scope. The invention will be described and explained with additional specificity and detail through the use of the accompanying drawings in which:

FIG. 1 illustrates an example system that permits a group of participants to access albums generated in an occasion-based social network;

FIGS. 2A and 2B are a flow charts of an example processes that may be implemented by an application in the system of FIG. 1; and

FIG. 3 is a block diagram illustrating an example computing device arranged for operating the occasion-based social network of FIG. 1, all arranged in accordance with at least some embodiments described herein.

### DESCRIPTION OF SOME EXAMPLE EMBODIMENTS

Embodiments described herein relate to an occasion-based social network. The social network enables access to media files, such as photographs (hereinafter “photos”), generated at an occasion by any number of individuals who attend the occasion. For simplicity in the discussion that follows, it is assumed that the media files include photos, with the understanding that the media files may alternately or additionally include video and/or other media files. The mechanisms by which the occasion-based social network virally engages participants attending an occasion are detailed herein. Specifically, the mechanisms include enabling participation to spread of an occasion without requiring a central authority or a single attendee at the occasion to explicitly establish a group or to expressly provide instructions to other individuals to participate.

Once engaged, the participants contribute photos generated at the occasion to a photo storage associated with the social network. The photos are viewable by attendees and others in the form of dynamically generated albums that are specifically tailored to each participant.

When used in connection with an occasion having multiple attendees, the social networks described herein enable access to media files, such as photographs (hereinafter “photos”), generated at an occasion by as many as all individuals who attend the occasion. For simplicity in the discussion that follows, it is assumed that the media files include photos, with the understanding that the media files may alternately or additionally include video and/or other media files. Additionally, the social networks generate a dynamic viewing experience that prioritizes photos shown to individuals during a viewing or browsing experience based on a dynamically generated social graph. Further details of a dynamically generated social graph and use thereof in a self-organizing way in connection with an occasion are provided in U.S. Provisional Patent Application No. 61/732,874, filed Dec. 3, 2012, entitled “Occasion-Based Social Network,” which is incorporated herein by reference.

The system includes processes that enable real-time, self-organizing, viral spreading of participation with the system by attendees of an occasion. For example, an attendee takes an initial photo with a mobile phone. If the attendee is registered with the social network, the system asks the attendee to name the occasion. Additionally, if the photo includes other attendees, the system asks the attendee to identify the individuals in the photo, which can include identifying the individuals from the attendee's mobile phone contact list. Additionally, the system asks the attendee to identify other attendees not in the photo, which again can include identifying the other attendees from the attendee's mobile phone contact list.

The system notifies the individuals and the other attendees identified by the attendee through SMS, email, mobile application notification, or some combination thereof to participate in the social network. When the individuals and the other attendees agree to participate, the individuals and the other attendees can see photos taken by other attendees at the occasion and their photos are automatically contributed to the album for the occasion.

The system asks the individuals and the other attendees who have agreed to participate some or all of the questions that were asked of the attendee who took the initial photo. In this way, participation spreads in a self-organizing fashion throughout the other attendees at the occasion as well as individuals who may be otherwise interested in the occasion. Note that, with this process, the individuals and the other attendees who participate in the social network may be close friends, associates, or even complete strangers. Additionally, the number of individuals and other attendees who participate in the social network regarding a specific occasion can vary greatly.

The system can infer potential participants based on individuals' locations and the time. The system may thus determine a probability of the individuals' attendance at an occasion for the occasion. For example, the system can use a global positioning system (GPS) of devices of individuals who are not yet participating in a currently progressing real-time album for an occasion to determine the locations of the individuals. Using the locations of the individuals who are not yet participating, along with information including locations and times of occasions input by participants, the system notifies the individuals who are not yet participating.

Additionally, the system detects when photos are generated on a mobile device operated by an individual who has not yet been linked with the occasion. Based on the location and time, the social network determines whether the individual generating the photo is attending the occasion in which others are participating or whether the photo is included in the individual's unorganized photostream. The system then notifies the individual to confirm the determination.

The system maintains contact details of individuals who have been notified, but who have not yet registered with the social network. The contact details are automatically provided to the system when an individual is tagged in a photo or the contact details are explicitly identified from a participant's contact list. Based on the contact details and any information provided by an individual during registration, such as email or mobile phone number, the system automatically pre-fills the remainder of the information about the individual to simplify registration. For example, the system may fill the individual's name, email address, etc.

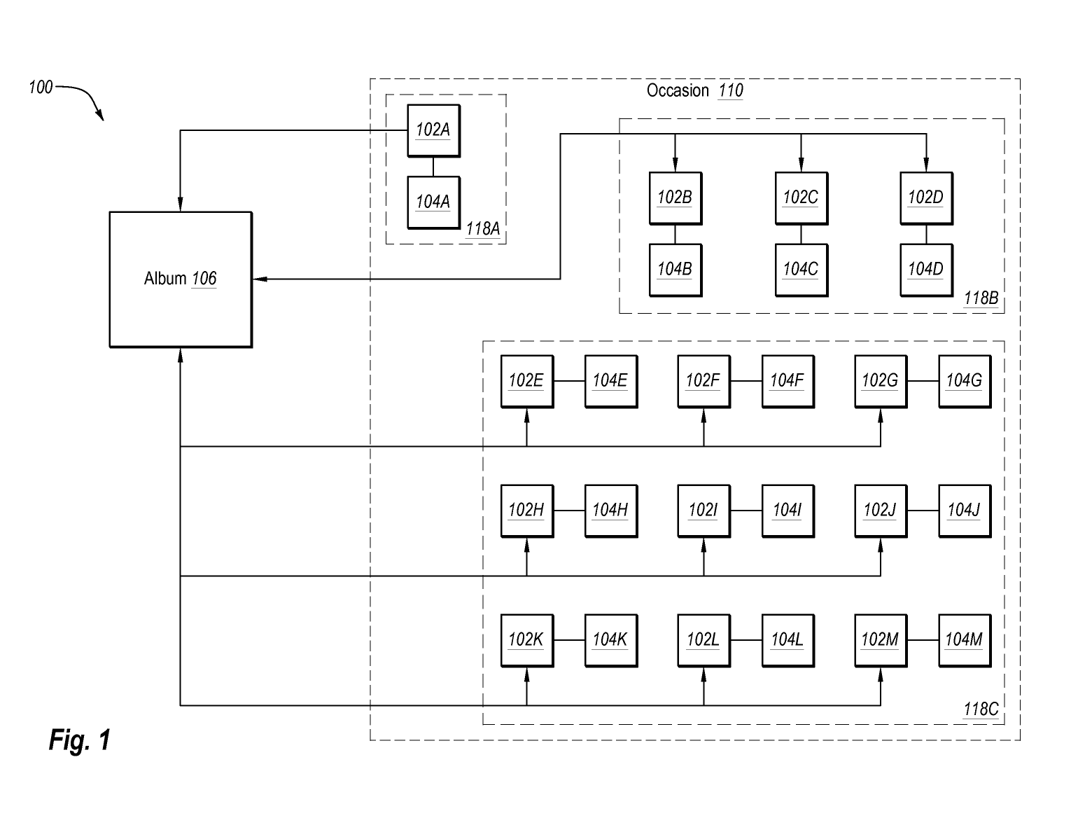

FIG. 1 illustrates an example system 100 that permits a group of participants to access albums generated in an occasion-based social network. Additionally, FIG. 1 provides a reference block diagram to assist in the explanation of the real-time, self-organizing, viral spreading of participation in an album 106 by multiple participants 104A-104M (generally, participant(s) 104) at an occasion 110.

The system 100 receives and stores photos generated at the occasion 110 by the participants 104. For simplification of the discussion included herein, the term photos is used for all media files generated at the occasion 110 including, but not limited to, photographs, video, other images, text messages, micro-blog or blog posts, or other types of media files. The system 100 receives the photos from multiple devices 102A-102M (generally, device(s) 102) which are operated by the participants 104. The system 100 then organizes the photos according to the occasion 110 at which the photos are generated in the album 106.

The occasion 110 can be any event including, but not limited to, a party, a public gathering, a celebration, or a vacation. Correspondingly, the occasion 110 can have different types of participants 104, different numbers of participants 104, and a variety of relationships among the participants 104. For example, the occasion 110 can be a honeymoon with two participants 104 who are recently married and therefore well acquainted. Alternatively, the occasion 110 can be a large wedding with hundreds of participants 104, some of which are strangers, some of which are friends, some of which are acquainted. Alternatively still, the occasion 110 can be a professional sporting event with thousands of participants 104 where a majority of the participants 104 are unacquainted except for small groups of acquainted participants 104.

The participants 104 benefit from the contribution of the photos from most, if not all, of the participants 104 attending the occasion 110. Accordingly, the system 100 provides a viral engagement process to spread participation among attendees of the occasion 110 and thereby increase the number of participants 104 contributing photos to a photo storage, which are subsequently viewable by each participant in the form of a dynamically generated album that is individually and automatically customized for that participant. The system 100 includes the capabilities to monitor the viral engagement process and the spread of participation at the occasion 110. By monitoring the viral engagement process, the system 100 can modify, determine, and continually improve the processes included in the viral engagement process.

Generally, to receive the photos from the occasion 110, the system 100 engages a first participant 104A attending the occasion 110. After engaging the first participant 104A, the system 100 identifies multiple other attendees of the occasion 110 based on information either provided during or ascertained from the interaction with the first participant 104A. The system 100 then engages the identified attendees. From information provided by the identified attendees or ascertained from the interaction with the identified attendees, the system 100 identifies additional attendees of the occasion 110. The system 100 then engages the additionally identified attendees. This viral engagement process continues until the population of attendees of the occasion 110, or a significant portion thereof, are participating in the system 100 and thus contributing photos to the album 106.

Integral to the viral engagement process are notifications and tagging processes according to some embodiments. Notifications allow the participants 104 to watch as the album 106 germinates, gathers momentum, evolves, and grows during the occasion 110. Additionally, the participants 104 are notified of contributions to the album 106 that involve the participants 104 while at the occasion in real-time. Notification by the system 100 are caused by social actions and are intended to encourage first time engagement and re-engagement by attendees, participants 104, and individuals. For example, notifications to an individual result from social actions involving the individual. The social actions include, but are not limited to, a participant (e.g., participant 104) selecting the individual from the contact list on his device (e.g., device 102) as an attendee of the occasion; a comment on a photo including the individual; a comment on a photo taken by the individual; a like on a photo including the individual; a like on a photo taken by the individual; the individual being tagged in a photo; when an album (e.g. the album 106) associated with the individual has achieved one or more thresholds, such as 10, 20, 50, 100, 150, 200, 500, 1000, 1500, 2000, etc. photos; and each time another individual or existing participant 104 participates in the social network for the first time at an occasion.

The notifications targeted at existing participant 104 may be transmitted as mobile push notification, and/or an email. The system 100 includes the option for participants 104 to opt out of email notifications. In contrast, the notifications targeted at non-participants vary based on whether the non-participant is at the occasion or it is after the occasion. While at the occasion, the notifications associated with at-occasion invites (discussed below), tagging, commenting, etc. are transmitted as SMS if a mobile number is available to the system 100 (discussed below). If the mobile number is not available, but an e-mail address is, the notifications are transmitted via email. After the occasion; however, the notifications targeted at non-participants associated with photo likes, comments, invites, etc. are transmitted via email.

The notifications include different types of links. Specifically, the notifications transmitted via a mobile push to the existing participants 104 include a link that sends the existing participants 104 to a target view of a mobile application providing access to system 100 and the associated social network. For example, a notification that someone commented on a photo of an individual links the individual back to that photo and/or a corresponding comment stream.

Additionally, notifications transmitted via SMS or email to non-participants, which are read on a mobile device include a link that sends the non-participant back to download the mobile application for the social network. The notification further includes a link to an authentication interface. The authentication interface acts as an impetus for the non-participant to register with the social network and become a new participant 104. Following authentication, the new participant 104 is sent to a target view in the mobile application for the social network displaying a photo or an album including the new participant 104.

Additionally, the notifications transmitted via email to participants 104 or non-participants, which are read on a desktop device includes another link. The link sends the participants 104 or the non-participant to a web-based application for the social network. At the web-based application, the participant 104 or the non-participant is sent to the target view displaying a photo or an album including the participant 104 or the non-participant, with no authentication required. Some additional details of the notifications are discussed below in combination with an example viral engagement process discussed with reference to FIG. 1.

The tagging processes include explicit tagging in which the system 100 identifies a face of an individual in a photo and confirms identification with a participant 104, who took the photo, to tag the individual. In explicit tagging, the system 100 prioritizes possible names for the participant 104 to choose from when the participant 104 is tagging an individual in a photo. The prioritization of possible names is based on information pertaining to other attendees at an occasion. With information pertaining to the attendees at the occasion, the system 100 can infer who is likely to be included the photo.

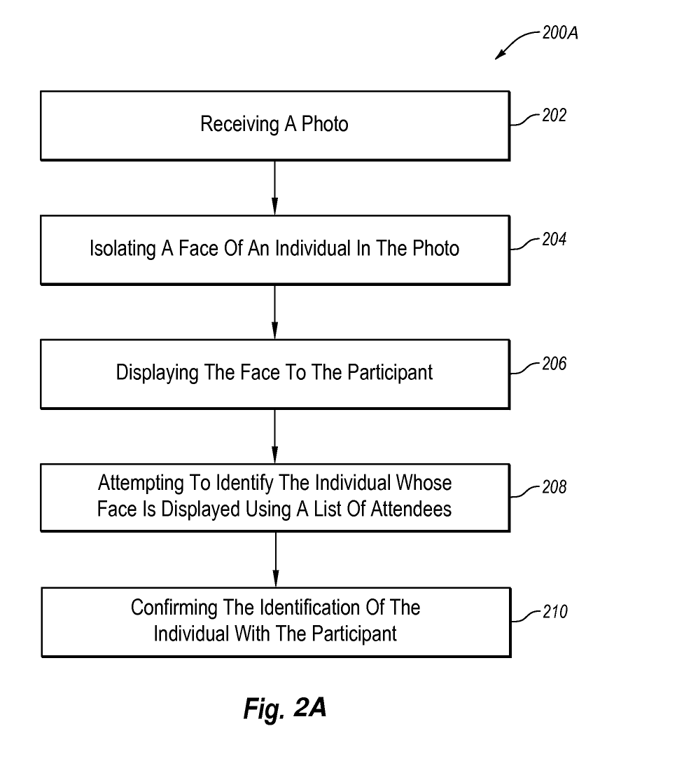

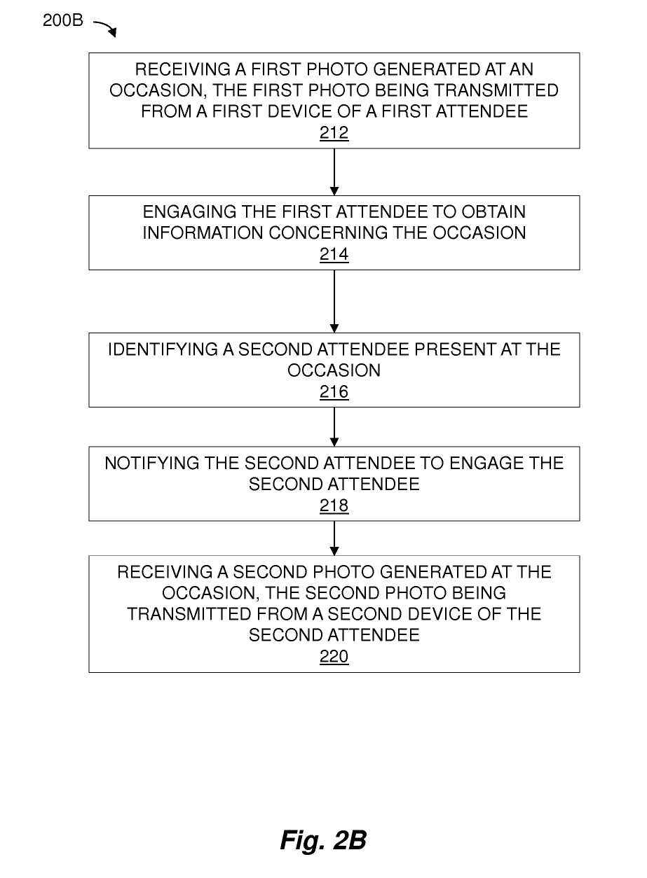

Additionally, the system 100 may implement automatic tagging. The system 100 may use the information pertaining to the attendees of an occasion with an ability of the system 100 to identify faces of the attendees to automatically identify and tag individuals included in photos. The system 100 limits a potential field of candidates for automatic tagging based on a social graph of an individual taking the photo and information pertaining to the occasion to reduces computation efforts used in automatically identifying faces and tagging individuals in photos. An example tagging flow is presented herein with respect to FIG. 2. Example embodiments of systems and methods for generating social graphs that may be implemented in the social network 100 of FIG. 1 in association with automatic tagging are described in provided in U.S. Provisional Patent Application No. 61/732874, filed Dec. 3, 2012, entitled “Occasion-Based Social Network,” which is incorporated herein by reference.

### Example Viral Engagement Process.

In this example, no authentication is needed by the system 100 during the viral engagement process. For simplicity of the explanation that follows, the participants 104 attending the occasion 110 are separated into three groups 118A-118C (generally, group(s) 118). The groups 118 are arbitrarily defined. A first group 118A includes the first participant 104A who operates a first device 102A. Engagement of the first participant 104A and/or the first group 118A with the system 100 is initiated by the first participant 104A. For example, the first participant 104A may have been exposed to an advertisement or discussion (e.g. on a blog, or a news story) of the system 100. Based on this exposure, the first participant 104A may desire to use the social network to store and share photos from the occasion 110. Alternatively, the first participant 104A may have previously used the social network and desires to use the social network at the occasion 110.

To engage the first participant 104A, the first participant 104A launches a device application loaded on the first device 102A. The system 100 takes the first participant 104A to the camera viewfinder of the first device 102A and prompts the first participant 104A to use the first device 102A to generate a first photo. More specifically, the system 100 prompts the first participant 104A to include other attendees in the first photo. The first photo is contributed to the album 106.

By immediately prompting the first participant 104A to generate the first photo, the system 100 allows the first participant 104A to generate a personal contribution before asking the first participant 104A for other information. The first photo gives the first participant 104A a stake in the social network and may increase the chance that the first participant 104A becomes fully engaged and actively participate with the social network. The first photo also ensures there is content in the album 106 for individuals invited by the first participant 104A to view.

The system 100 then prompts the first participant 104A to provide information pertaining to the occasion 110. For example, the system 100 inquires as to a name of the occasion 110, other attendees of the occasion 110, a number of attendees at the occasion 110, the address of the occasion, or some combination thereof. In some circumstances, the system may automatically ascertain the address using a global positioning system (GPS) on one of the devices at the occasion 110. The system also records the time of the occasion 110.

Additionally or alternatively, the system 100 verifies the first device 102A is connected to the GPS to receive GPS coordinates for a location of the first device 102A. If the first device 102A is not connected to the GPS, system 100 prompts the first participant 104A to connect the first device 102A to the GPS. When the first device 102A is connected to the GPS, the system 100 requests the GPS coordinates from the first device 102A to determine a location of the occasion 110 and a time of the occasion 110. Based on the location and the time of the occasion 110, the system 100 infers the name and/or type of the occasion 110. The system 100 then communicates to the first participant 104A the inferred name and/or type of the occasion 110 to confirm the inference regarding the occasion 110. If the inference of the device application is incorrect, then the system 100 communicates an inquiry to the first participant 104A for information pertaining to the occasion 110 as discussed above.

For example, when the first participant 104A submits a first photo, the device application determines, from the GPS coordinates of the first device 102A, that the location of the occasion 110 is a football stadium at 5:30 p.m. on a Sunday. Accordingly, based on the location and the time, the system 100 infers that the occasion 110 is a football game and perhaps the teams participating in the game. The system 100 then transmits an inquiry to the first participant 104A to confirm that the occasion 110 is the inferred football game.

The system 100 then attempts to identify other attendees of the occasion 110 by communicating an inquiry to the first participant 104A. The inquiry requests contact details of other attendees known to the first participant 104A. Additionally, the system 100 interfaces with a contact list on the first device 102A to display the contact list to the first participant 104A. The first participant 104A then selects the attendees known to the first participant 104A who are attending the occasion 110 from the contact list.

The system 100 also identifies other participants 104 by interfacing with the GPS coordinates received by the other devices 102. The system 100 compares the location provided by the first participant 104A and/or inferred from the GPS information requested from other devices 102. The system 100 then infers that attendees operating the devices 102 in the same location are attending the occasion 110.

The system 100 also identifies attendees of the occasion 110 by reading metadata of photos contributed to the album 106. For example, the first participant 104A tagged three individuals in the first photo. The metadata associated with the first photo thus reflects the tagged individuals who are likely attending the occasion 110. Thus, system 100 reads the metadata identifying the tagged individuals and then transmits invitations to participate to the tagged individuals if they have not yet done so. The first participant 104A may use a tagging process described elsewhere herein to tag the individuals included in the first photo.

The system 100 generates a list of attendees it knows or infers to be at the occasion 110 and presents the list of attendees to the first participant 104A. The first participant 104A then provides contact details for the attendees that are known to the first participant 104A. In some embodiments, when the list of attendees presented to the participant 104 is longer than a list length specified by the first participant 104A or otherwise dictated by the system 100, the system 100 instead presents a subset of the list of attendees. For example, the occasion 110 may be a large public event, such as an outdoor concert. The system 100 generates a list of hundreds of attendees in such embodiments. To avoid frustrating the first participant 104A, the device application only presents a subset of the list of attendees, for example, about twenty attendees.

For explanatory purposes, the participants 104 identified as attendees by engagement of the first participant 104A are included in a second group 118B. Generally, the second group 118B includes more participants 104 than the first group 118A. However, in some circumstances, the second group 118B can include the same or fewer participants 104 than the first group 118A. In FIG. 1, the second group 118B includes a second participant 104B, a third participant 104C, and a fourth participant 104D (generally referred to as second group participants).

The system 100 attempts to engage the second group participants with the notifications described above. By notifying the second group participants, the system 100 engages the second group participants such that they contribute photos to the album 106 for the occasion 110.

Specifically, the system 100 engages the second group participants by notifying the second group participants of the opportunity to contribute photos to the album 106. As mentioned above, through the interactions with the first participant 104A, the system 100 accesses contact details of the second group participants. Thus, the system 100 can transmit a notification via an SMS, email, social network push, mobile push, or another appropriate channel depending on the available contact details for the second group participants and whether they have previously registered with the system or not.

For example, the first participant 104A has the contact details, such as a mobile phone number of the device 102B, of the second participant 104B and provides the contact details to the system 100. The social network then transmits an SMS to the second participant 104B to engage the second participant 104B in the social network Likewise, if the third participant 104C is tagged by the first participant 104B in the first photo, the system 100 reads the metadata from the first photo and requests contact details for the third participant 104C. The system 100 then transmits an SMS to the third participant 104C to engage the third participant 104C in the social network. The SMS notification transmitted to the third participant 104C and/or the second participant 104B includes a link to the system 100 as described above.

In some embodiments, when the second participant 104B and/or the third participant 104C are engaged by the social network, the other participants 104 already engaged by the social network for the occasion 110 receive a notification indicating the engagement of a new participant 104 at the occasion 110. In an example, the first participant 104A and the third participant 104C are already engaged by the device application. The second participant 104B and the fourth participant 104D received an SMS attempting to engage them. When the second participant 104B or the fourth participant 104D is engaged by the social network, the first participant 104A, and the third participant 104C receive a notification that the second participant 104B or the fourth participant 104D is has been engaged by the social network. Alternately or additionally, after the first, second third and fourth participants 104A-104D have all been engaged by the social network, each may receive a notification when any of the others contributes photos to the album 106. A potential benefit of the notification of engaging each participant 104 includes a feeling by the participants 104 of a building momentum at the occasion 110.

Once engaged, the second group participants contribute the photos they take at the occasion 110 to the album 106. The system 100 then attempts to identify more attendees of the occasion 110. As described above, the system 100 attempts to identify attendees by reading metadata of the photos contributed to the album 106, by interfacing with one or more systems of the devices 102, by communicating inquiries to the second group participants, or some combination thereof.

For explanatory purposes, the participants 104 identified as attendees by engagement of the second group participants include a third group 118C. Generally, the third group 118C includes more participants 104 than the first group 118A or the second group 118B. However, in some circumstances, the third group 118C includes the same or fewer participants 104 than the first group 118A and/or the second group 118B. In FIG. 1, the third group 118C includes a fifth participant 104E, a sixth participant 104F, a seventh participant 104G, an eighth participant 104H, a ninth participant 104I, a tenth participant 104J, an eleventh participant 104K, a twelfth participant 104L, and a thirteenth participant 104M (generally referred to as third group participants).

Like the second group participants, the third group participants are notified by the system 100 of the opportunity to contribute photos generated at the occasion 110. In response to notifications communicated by the device application, the third group participants become engaged with the social network and contribute photos to the album 106.

The system 100 then attempts to identify more attendees of the occasion 110 by reading metadata of the photos communicated to the album 106 by the third group participants, by interfacing with one or more systems of the devices 102 operated by the third group participants, by communicating inquiries to the third group participants, or some combination thereof.

The system 100 maintains contact details of attendees, participants 104, and other individuals who have been notified, but who have not yet been wholly engaged with the social network. Based on the contact details and any information provided by an individual during registration, such as email or mobile phone number, the system 100 automatically pre-fills the remainder of the information about the individual to simplify registration. For example, the system 100 automatically fills the individual's name, email address, etc.

### Example Tagging Process.

As discussed above, the system 100 enables the participants 104 to tag individuals and/or objects in the photos contributed to the album 106. Tagging can occur while the participants 104 are attending the occasion 110 and/or later when one of the participants 104 or another individual is viewing the photos of the album 106. Accordingly, the system 100 includes one or more tagging applications.

FIG. 2A is a flow chart illustrating an example tagging process 200A that can be implemented by the system 100 of FIG. 1. One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

The process 200A begins at 202 by receiving a photo. For example, the photo can be generated by a participant operating a device configured to contribute photos to an album. Once the photo is generated, the photo is contributed via a device application running on the device. For example, the photo may be generated by one of the devices 102 and contributed to the album 106 of FIG. 1.

At 204, the process 200A includes isolating a face of an individual in the photo. Isolating the face can be conducted using a cropping tool or facial recognition software implemented locally on the device or remotely at the system 100. Isolating the face generally includes outlining the face, removing portions of the photo other than the face and enlarging or otherwise highlighting the face.

At 206, the process 200A includes displaying the face to the participant. The displaying can be in real time, immediately following the generation of the photo, or subsequent to an occasion at which the photo was generated. Displaying the face can be requested by the participant or automatically initiated by the social network.

At 208, the process 200A includes attempting to identify the individual whose face is displayed using a list of attendees. The list of attendees includes attendees identified as attending the occasion as described above with reference to FIG. 1. The list of attendees can be periodically or continuously updated. In some embodiments, the tagging application tracks or otherwise records the previously tagged participants attending the occasion to establish preferred or likely participants that are likely to be tagged in future photos.

At 210, the process 200A includes confirming the identification of the individual with the first participant. When the attempt to identify the individual is incorrect, the process 200A can also include displaying a subset of the list of attendees. When the attempt to identify the individual is correct, the process 200A includes offering to create a new contact in the first device of the identified individual.

### Example Engagement Process.

As discussed above, the system 100 enables viral engagement of the participants 104. Accordingly, the system 100 includes one or more viral engagement applications. FIG. 2B is a flow chart illustrating an example viral engagement process 200B that can be implemented by the system 100 of FIG. 1. One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

At 212, the viral engagement process 200B may begin by receiving a first photo generated at an occasion. The first photo may be transmitted from a first device of a first attendee.

At 214, the viral engagement process 200B may include engaging the first attendee to obtain information concerning the occasion. In some embodiments, the engaging the first attendee includes prompting the first attendee for information pertaining to the occasion and inquiring as to a list of individuals to be included in other attendees. The information pertaining to the occasion may include an address of the occasion, a number of people attending the occasion, individuals attending the occasion, a name of the occasion, or some combination thereof.

At 216, the viral engagement process 200B may include identifying a second attendee present at the occasion. At 218, the viral engagement process 200B may include notifying the second attendee to engage the second attendee. At 220, the viral engagement process 200B may include receiving a second photo generated at the occasion, the second photo being transmitted from a second device of the second attendee.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For example, the viral engagement process 200B may include engaging the second attendee to obtain information concerning the occasion.

Additionally or alternatively, the viral engagement process 200B may include identifying other attendees through engaging the second attendee. In some embodiments, identifying the second attendee and/or identifying other attendees may include one or more of reading individuals tagged in the first photo and/or the second media, accessing contacts in the first device and/or the second device, and accessing global positioning signals received by the first device, the second device or any of multiple devices associated with any of the other attendees.

Additionally or alternatively, the viral engagement process 200B may include providing public access to the first photo and the second photo and/or determining the occasion. In some embodiments determining the occasion may include accessing a global positioning signal on the first device of the first attendee. Additionally, in these and other embodiments, determining the occasion may include prompting the first attendee in real time or prompting the first attendee in advance of determining the occasion.

Additionally or alternatively, the viral engagement process 200B may include creating ties between strangers based on the strangers being at the same occasion and/or notifying one or more of the attendees or notifying an individual based on a social action.

In some embodiments, the social action includes: selecting an individual or one of the attendees from the contact list on the first device or the second device as one of the attendees, commenting on a photo including the individual or one of the attendees, commenting on a photo taken by the individual or one of the attendees, liking a photo including the individual or one of the attendees, liking a photo taken by the individual or one of the attendees, the individual or one of the attendees being tagged in a photo, when an album associated with the individual or one of the attendees has achieved one or more thresholds, each time another individual or attendee who already has been engaged in the social network transmits a photo for the first time at the occasion, or some combination thereof. In some embodiments, the thresholds comprise one or more of 10, 20, 50, 100, 150, 200, 500, 1000, 1500, or 2000 photos.

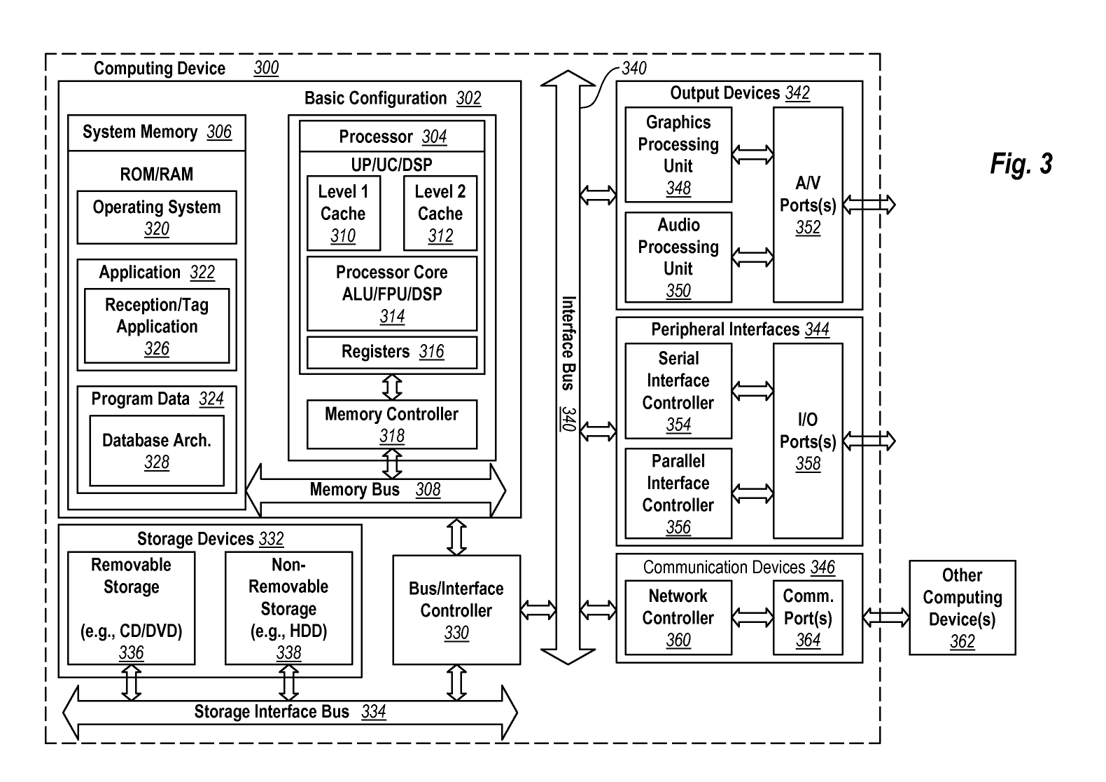

FIG. 3 is a block diagram illustrating an example computing device 300 arranged for operating a social network, such as the social network associated with the system 100 of FIG. 1, arranged in accordance with at least some embodiments described herein. In a very basic configuration 302, the computing device 300 typically includes one or more processors 304 and a system memory 306. A memory bus 308 may be used for communicating between the processor 304 and the system memory 306.

Depending on the desired configuration, the processor 304 may be of any type including but not limited to a microprocessor (μP), a microcontroller (μC), a digital signal processor (DSP), or any combination thereof. The processor 304 may include one or more levels of caching, such as a level one cache 310 and a level two cache 312, a processor core 314, and registers 316. An example processor core 314 may include an arithmetic logic unit (ALU), a floating point unit (FPU), a digital signal processing core (DSP Core), or any combination thereof. An example memory controller 318 may also be used with the processor 304, or in some implementations the memory controller 318 may be an internal part of the processor 304.

Depending on the desired configuration, the system memory 306 may be of any type including but not limited to volatile memory (such as RAM), non-volatile memory (such as ROM, flash memory, etc.) or any combination thereof. The system memory 306 may include an OS 320, one or more applications 322, and program data 324. The application 322 may include a reception or tagging application 326 (in FIG. 3 “Reception/Tag. Application”) which may include tagging algorithms, reception algorithms, inquiry algorithms, and/or other algorithms or applications such as an engagement application (not shown) that may be arranged to perform the functions as described herein. The program data 324 may include a database architecture and data storage arrangements 328 (in FIG. 3, “Database Arch.”) for example that may identify and organize the photos according to an occasion as is described herein. In some embodiments, the application 322 may be arranged to operate with the program data 324 on the OS 320 such that methods for managing a social network, engaging participants in a social network, and/or tagging photos may be provided as described herein. This described basic configuration 302 is illustrated in FIG. 3 by those components within the inner boxed area.

The computing device 300 may have additional features or functionality, and additional interfaces to facilitate communications between the basic configuration 302 and any required devices and interfaces. For example, a bus/interface controller 330 may be used to facilitate communications between the basic configuration 302 and one or more data storage devices 332 via a storage interface bus 334. The data storage devices 332 may be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 306, removable storage devices 336, and non-removable storage devices 338 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 300. Any such computer storage media may be part of the computing device 300.

The computing device 300 may also include an interface bus 340 for facilitating communication from various interface devices (e.g., output devices 342, peripheral interfaces 344, and communication devices 346) to the basic configuration 302 via the bus/interface controller 330. Example output devices 342 include a graphics processing unit 348 and an audio processing unit 350, which may be configured to communicate to various external devices such as a display or speakers via one or more A/V ports 352. Example peripheral interfaces 344 include a serial interface controller 354 or a parallel interface controller 356, which may be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which may be arranged to facilitate communications with one or more other computing devices 362 over a network communication link via one or more communication ports 364.

The present invention may be embodied in other specific forms without departing from its spirit. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A viral engagement process for increasing participation in an occasion-based social network, the process comprising:
receiving a first photo generated at an occasion, the first photo being transmitted from a first device of a first attendee;
engaging the first attendee to obtain information concerning the occasion;
identifying a second attendee present at the occasion;
notifying the second attendee to engage the second attendee; and
receiving a second photo generated at the occasion, the second photo being transmitted from a second device of the second attendee.

2. The process of claim 1, further comprising engaging the second attendee to obtain information concerning the occasion.

3. The process of claim 1, further comprising identifying a plurality of other attendees through engaging the second attendee.

4. The process of claim 3, further comprising enabling tagging of one or more individuals included in the first photo and/or the second photo.

5. The process of claim 4, wherein enabling tagging comprises:
receiving the first photo;
isolating a face of an individual in the first photo;
displaying the face to the first attendee;
attempting to identify the individual whose face is displayed using a list including the plurality of other attendees; and
confirming the identification of the individual with the first attendee.

6. The process of claim 5, wherein enabling tagging further comprises:
when the attempt to identify the individual is incorrect, displaying a subset of the list including the plurality of other attendees; and
when the attempt to identify the individual is correct, offering to create a new contact for the identified individual in the first device.

7. The process of claims 3, wherein identifying the second attendee and/or identifying the plurality of other attendees comprises one or more of:
reading individuals tagged in the first photo and/or the second media;
accessing contacts in the first device and/or the second device; and
accessing global positioning signals received by the first device, the second device or any of a plurality of devices associated with any of the plurality of other attendees.

8. The process of claim 3, further comprising providing public access to the first photo and the second photo.

9. The process of claim 3, wherein the photo comprises photographs and videos.

10. The process of claim 1, wherein engaging the first attendee comprises:
prompting the first attendee for information pertaining to the occasion; and
inquiring as to a list of individuals to be included in other attendees.

11. The process of claim 10, wherein the information pertaining to the occasion comprises:
an address of the occasion;
a number of people attending the occasion;
individuals attending the occasion; and
a name of the occasion.

12. The process of claim 11, further comprising determining the occasion.

13. The process of claim 12, wherein determining the occasion comprises accessing a global positioning signal on the first device of the first attendee.

14. The process of claim 12, wherein determining the occasion comprises prompting the first attendee in real time or prompting the first attendee in advance of determining the occasion.

15. The process of claim 12, further comprising creating ties between strangers based on the strangers being at the same occasion.

16. The process of claim 3, further comprising:
notifying one or more of the plurality of attendees or notifying an individual based on a social action.

17. The process of claim 16 wherein the social action comprises:
selecting an individual or one of the plurality of attendees from the contact list on the first device or the second device as one of the plurality of attendees;
commenting on a photo including the individual or one of the plurality of attendees;
commenting on a photo taken by the individual or one of the plurality of attendees;
liking a photo including the individual or one of the plurality of attendees;
liking a photo taken by the individual or one of the plurality of attendees;
the individual or one of the plurality of attendees being tagged in a photo;
when an album associated with the individual or one of the plurality of attendees has achieved one or more thresholds; or
each time another individual or attendee who already has been engaged in the social network transmits a photo for the first time at the occasion.

18. The process of claim 17, wherein the thresholds comprise one or more of 10, 20, 50, 100, 150, 200, 500, 1000, 1500, or 2000 photos.

19. A data structure, residing in a tangible computer-readable medium, having stored thereon one or more instructions, that when executed by a processor perform the processes as recited in claim 1.
